(19) United States
(12) Patent Application Publication
(10) Pub. No.: US 2011/0161856 A1
(43) Pub. Date: Jun. 30, 2011

(54) DIRECTIONAL ANIMATION FOR COMMUNICATIONS

(75) Inventors: Mikko A. NURMI, Tampere (FI); Ilkka SALMINEN, Tampere (FI)

(73) Assignee: Nokia Corporation, Espoo (FI)

(21) Appl. No.: 12/647,992

(22) Filed: Dec. 28, 2009

(51) Int. Cl. G06F 3/048; G06F 15/16

(52) U.S. Cl. 715/772; 709/206

(57) ABSTRACT

A method, apparatus, user interface and computer program product for detecting in a communication device a communication between a sender and a recipient, determining a location of the sender, determining a location of the recipient, determining a direction between the location of the recipient relative to the location of the sender, and providing a directional animation on a display of the communication device, wherein the directional animation is generally in a direction from the location of the sender towards the location of the recipient.

### TECHNICAL FIELD

The aspects of the disclosed embodiments generally relate to communications, and in particular to providing animated directional information during communications.

### BACKGROUND

When a call is made, one party will very often inquire as to the geographical location of the other party. Such an inquiry is especially common when the caller and the recipient are planning to meet, or when one or both parties are trying to get to a specific geographical location. Additionally, one party may wish to obtain additional information about, or may have a special interest in, the general geographical location of the other party. This can include obtaining directions to the location of the other party or realizing that there are attractions, services and traffic or weather conditions in the area of the other party. Current technologies do not automatically provide a call recipient's geographical location to a caller, and do not provide additional information about the call recipient's geographical location.

It would be advantageous to be able to provide location and direction information pertaining to a recipient of a communication on a display of a device. It would also be advantageous to be able to direct a caller to a location of the recipient based upon the call information. Accordingly, it would be desirable to address at least some of the problems identified above.

### SUMMARY

In one aspect a method includes detecting in a communication device a communication between a sender and a recipient, determining a location of the sender and a location of the recipient, determining a direction between the location of the recipient relative to the location of the sender, and providing a directional animation on a display of the communication device, wherein the directional animation is generally in a direction from the location of the sender towards the location of the recipient.

In another aspect, an apparatus includes a location module processor configured to determine location data corresponding to a geographical location of a sender and a recipient to a communication, and a directional animation module processor configured to receive the location data and provide a directional animation on a display of a communication device, the directional animation configured to indicate a relative direction from a location of the sender of the communication towards a location of the recipient of the communication.

### BRIEF DESCRIPTION OF THE DRAWINGS

The foregoing aspects and other features of the embodiments are explained in the following description, taken in connection with the accompanying drawings, wherein:

FIG. 1A is a block diagram of a system incorporating aspects of the disclosed embodiments;

FIG. 1B is a block diagram of an exemplary device incorporating aspects of the disclosed embodiments;

FIGS. 2A-2J are screenshots illustrating aspects of the disclosed embodiments;

FIGS. 3A-3E are screenshots illustrating aspects of the disclosed embodiments;

FIGS. 4A-4C are screenshots illustrating aspects of the disclosed embodiments;

FIGS. 5A-5D are screenshots illustrating aspects of the disclosed embodiments;

FIGS. 6A and 68 are illustrations of exemplary devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 6A and 6B may be used.

### DETAILED DESCRIPTION OF THE EMBODIMENT(S)

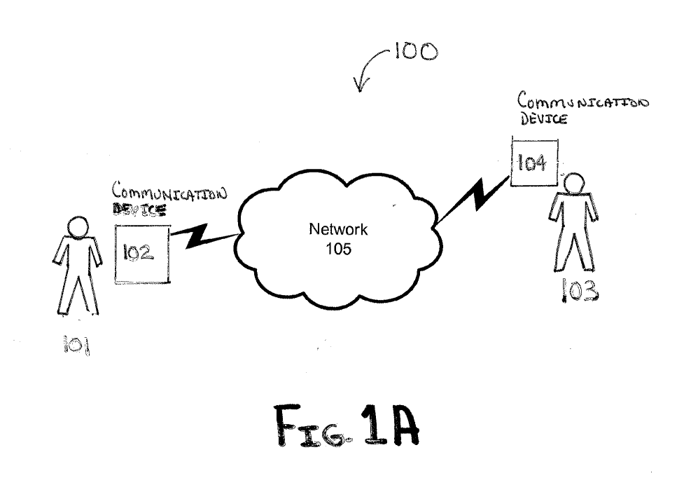

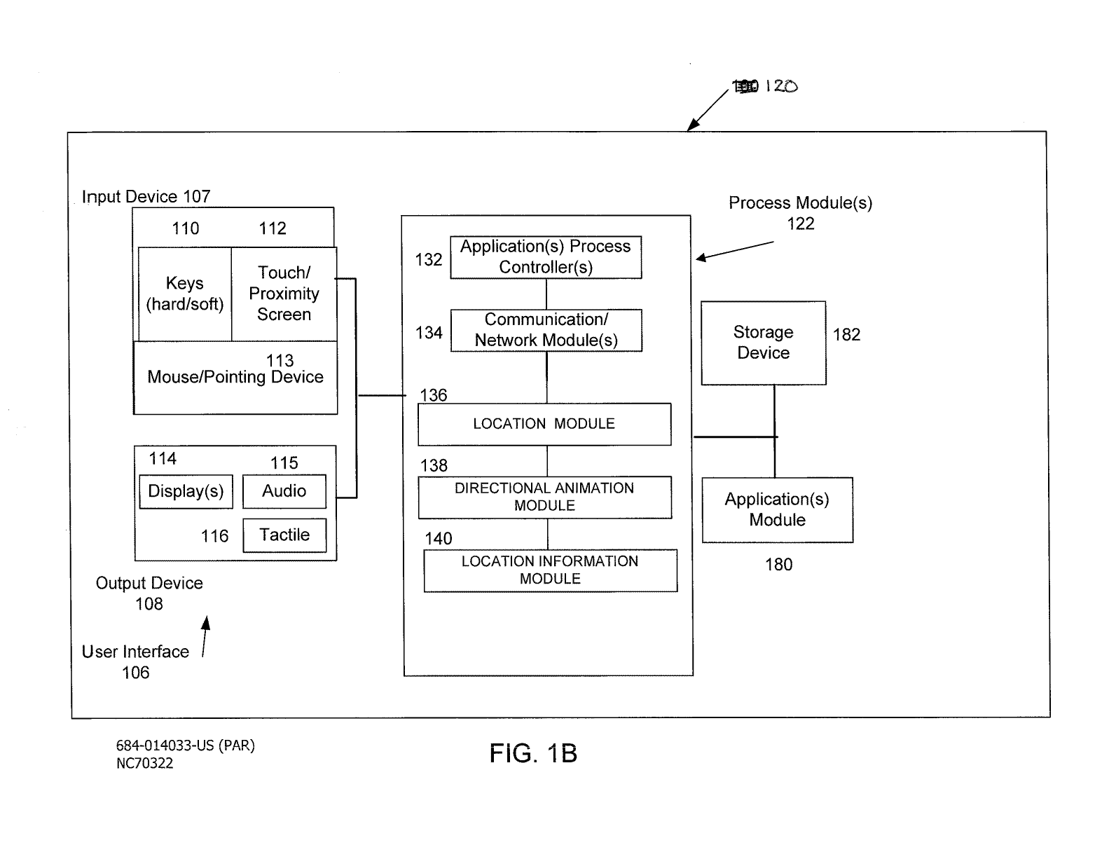

FIG. 1A illustrates one embodiment of a system 100 in which aspects of the present application can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments are generally directed to using augmented reality (AR) in communication devices while sending or receiving communications and allowing a user to follow or see where a sent communication goes, or to see where a received communication comes from. In one embodiment, during a communication, location information pertaining to each of the sending and receiving device is collected or otherwise obtained. The location data is then evaluated in order to provide directional or other geographical information related to the location of one or more of the devices, such as for example, directional data between the sender and the recipient(s). Although the aspects of the disclosed embodiments will be generally described herein with respect to a recipient, it will be understood that a communication can have more than one recipient. For example, a communication, such as a call, text or email can have multiple recipients. A conference call will have multiple parties to the call. The aspects of the disclosed embodiments can be applied to the situation where the communication has multiple recipients.

In one embodiment, the directional information is provided in the form of an animation. Animation, as that term is used herein, is generally intended to include any suitable directional or geographical indicator(s), and can be in the form of a two or three-dimensional graphical image or representation. In alternate embodiments, any suitable indicator or feedback can be used to provide directional information, such as including, but not limited to, audio and tactile feedback of the device, or three-dimensional sounds. In one embodiment, the animation can also include information such as a distance between the sender and the recipient(s) can also be provided. Further information pertaining to the respective location or locations can also be provided, such as the names of the respective locations, and services in the general area. The user is thus provided with feedback related to a location of the recipient(s) of a communication by the presentation of one or more of directional, geographic and/or other location related information. The term “location”, “direction” or “directional” information, as used herein, are generally intended to include or refer to such information and data. Although the aspects of the disclosed embodiments will generally be described with respect to a sender receiving location information on a recipient, the situation could also be where the recipient receives and similarly uses the location information as is described herein. Thus, the terms “user” and “other party” will be used to describe the “sender” and “recipient” interchangeably, and these terms can also include plurals of each party.

As shown in FIG. 1A, a communication(s) can be sent from a communication device 102 of a sender 104 to a communication device 104 of a recipient 103 through a network 105. The communication devices 102, 104 can be any devices that are capable of, or configured to, communicate with, or provide communications capability with each other or other devices. This includes the sending and/or receiving of communications. Examples of these devices can include, but are not limited to, mobile telephones, mobile computers, personal data assistants (PDA), wirelessly networked computers and wired communication devices, such as telephones and computers. A “communication” as that term is used herein, is generally intended to encompass any communication between one or more parties, and can include for example, telephone calls, teleconference calls, voice over Internet protocol (VOIP) calls, push-to-talk calls and messages, text messaging, multimedia messaging and electronic mail, chat messages, blog posts and replies. Communications can also include social networking communications and posts, such as for example, Facebook™ profile comments and messages, Twitter™ tweets and comments, and comments on user images. In the example of the Facebook™ profile, the directional or location information will pertain to the user commenting on the Facebook™ profile and the owner of the profile.

The network 105 shown in FIG. 1A generally provides the communication devices 102, 104 with access to telecommunication services, including, but not limited to cellular telephone services, the Internet, messaging and email services, or any other network capable of providing communication services, such as those listed above and otherwise described herein.

FIG. 1B illustrates one embodiment of an exemplary communication device or apparatus 120 that can be used in the system 100 of FIG. 1A. The communication device of FIG. 1B generally includes a user interface 106, process modules 122, applications module 180, and storage device(s) 182. In alternate embodiments, the device 120 can include other suitable systems, devices and components that provide for using augmented reality in a communication device in conjunction with the sending and receiving of communications, and animating directional information. The components described herein are merely exemplary and are not intended to encompass all components that can be included in, or used in conjunction with the device 120. The components described with respect to the device 120 will also include one or more processors or computer program products to execute the processes, methods, sequences, algorithms and instructions described herein.

The user interface 106 of the device 120 generally includes input device(s) 107 and output device(s) 108. The input device(s) 107 are generally configured to allow for the input of data, instructions, information, gestures and commands to the device 120. The input device 107 can include one or a combination of devices such as, for example, but not limited to, keys or keypad 110, touch sensitive area or proximity screen 112 and a mouse or pointing device 113. In one embodiment, the keypad 110 can be a soft key(s) or other such adaptive or dynamic device of a touch screen 112. The input device 107 can also be configured to receive input commands remotely or from another device that is not local to the device 120. The input device 107 can also include camera devices (not shown) or other such image capturing system(s).

The output device(s) 108 is generally configured to allow information and data to be presented to the user and can include one or more devices such as, for example, a display 114, audio device 115 and/or tactile output device 116. In one embodiment, the output device 108 can also be configured to transmit information to another device, which can be remote from the device 120. While the input device(s) 107 and output device(s) 108 are shown as separate devices, in one embodiment, the input device(s) 107 and output device(s) 108 can comprise a single device, such as for example a touch screen device, and be part of and form, the user interface 106. For example, in one embodiment where the user interface 106 includes a touch screen or proximity device, the touch sensitive screen or area 112 can also provide and display information, such as keypad or keypad elements and/or character outputs in the touch sensitive area of the display 114. While certain devices are shown in FIG. 1B, the scope of the disclosed embodiments is not intended to be limited by any one or more of these devices, and alternate embodiments can include or exclude one or more devices shown.

The process module 122 is generally configured to execute the processes and methods of the aspects of the disclosed embodiments. As described herein, the process module 122 is generally configured to use location information corresponding to the locations of the sender 101 and recipient(s) 103 to determine and present directional information on the communication device 102 of the sender 101. It should be noted that although the location of the sender 101 and recipient(s) 103 are referred to herein, it is the locations of the respective devices 102 and 104 that are determined and utilized with respect to the aspects of the present application. In one embodiment, the directional information is presented as an animation and can include other direction and location information data related to the location of the sender 102 and/or recipient 103.

In one embodiment, the process module 122 includes a location module 136, a directional animation module 138, and a location services module 140. In alternate embodiments, the process module 122 can include any suitable function or application modules that provide for determining a location of communication devices and using the determined location information to present a directional indicator or animation on the display of a communication device, as well as to provide additional location information as is described herein.

The application process controller 132 shown in FIG. 1B is generally configured to interface with the applications module 180 and execute applications processes with respects to the other modules of the device 120. In one embodiment the applications module 180 is configured to interface with applications that are stored either locally to or remote from the device 120. The applications module 180 can include or interface with any one of a variety of applications that may be installed, configured or accessible by the device 120, such as for example, office, business, media players and multimedia applications, web browsers, global positioning applications, navigation and position systems and locations and map applications. The applications module 180 can also include a voice recognition system that includes a text-to-speech module that allows the user to receive and input voice commands, prompts and instructions, through a suitable audio input device. In alternate embodiments, the applications module 180 can include any suitable application that can be used by or utilized in the processes described herein. For example, in one embodiment, the applications module 180 can interface with a navigation and position system in order to determine a location of the sender 101 and recipient(s) 103 and obtain enhanced service level information related to one or both of the locations. The location information can then be used to develop the directional animation described herein, as well as provide the user with other information related to the location of the respective parties.

The communication module 134 shown in FIG. 1B is generally configured to allow the device 120 to receive and send communications and data including for example, telephone calls, text messages, location and position data, navigation information, chat messages, multimedia messages, video and email. The communications module 134 is also configured to receive information, data and communications from other devices and systems or networks, such as for example, the Internet. In one embodiment, the communications module 134 is configured to interface with, and establish communications connections with other services and applications using the Internet.

The aspects of the disclosed embodiments utilize location data obtained by the location module 136 during a communication pertaining to the sender 101 and the recipient 103. The location module 136 is generally configured to determine or obtain the location data and can include, or is capable of interfacing with, global positioning applications, cellular identification based location detection systems, indoor positioning devices, navigation and position systems, location and map applications, routing systems and other device or system configured to obtain or provide location detection. The location data determined or obtained by the location module 136 can be provided to, for example, the directional animation module 138, for use in developing and presenting directional animation during communication(s) as is generally described herein.

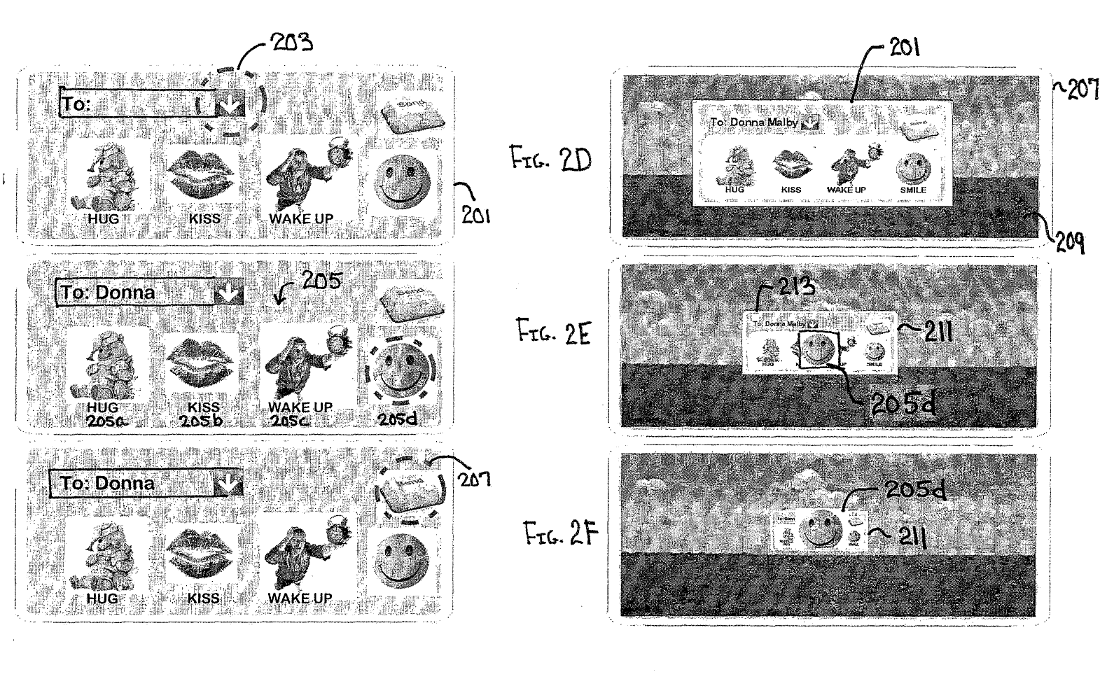

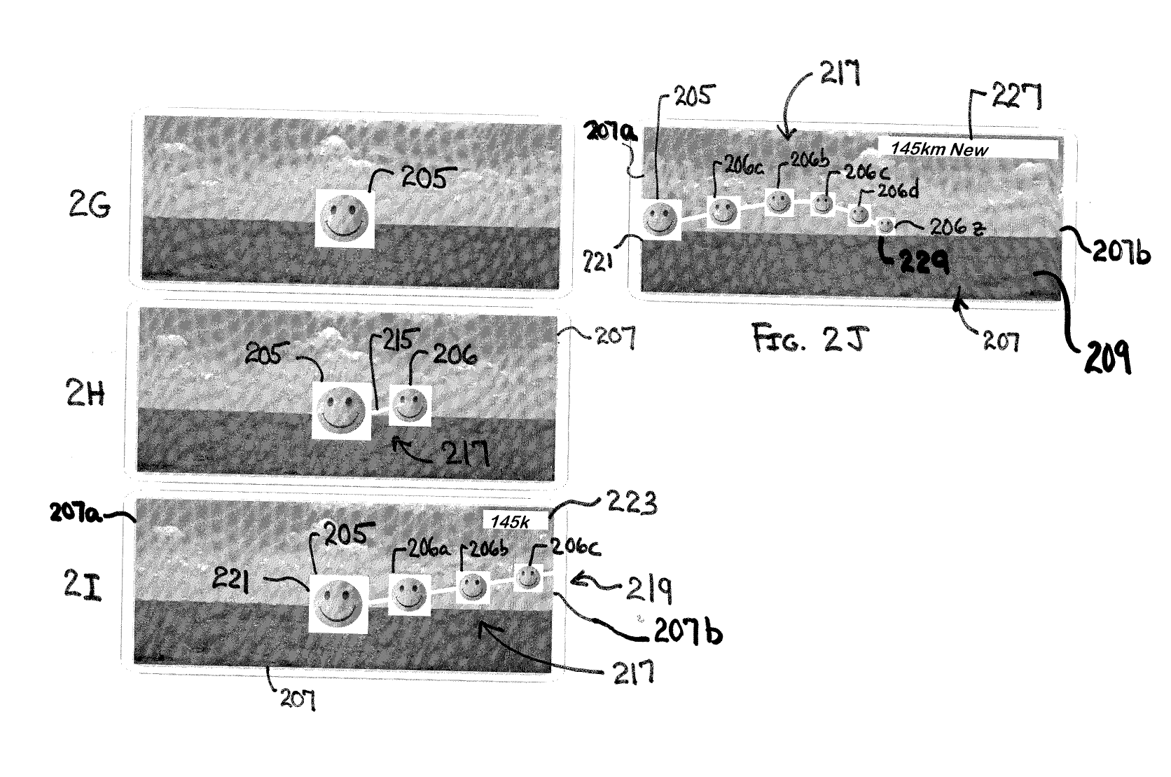

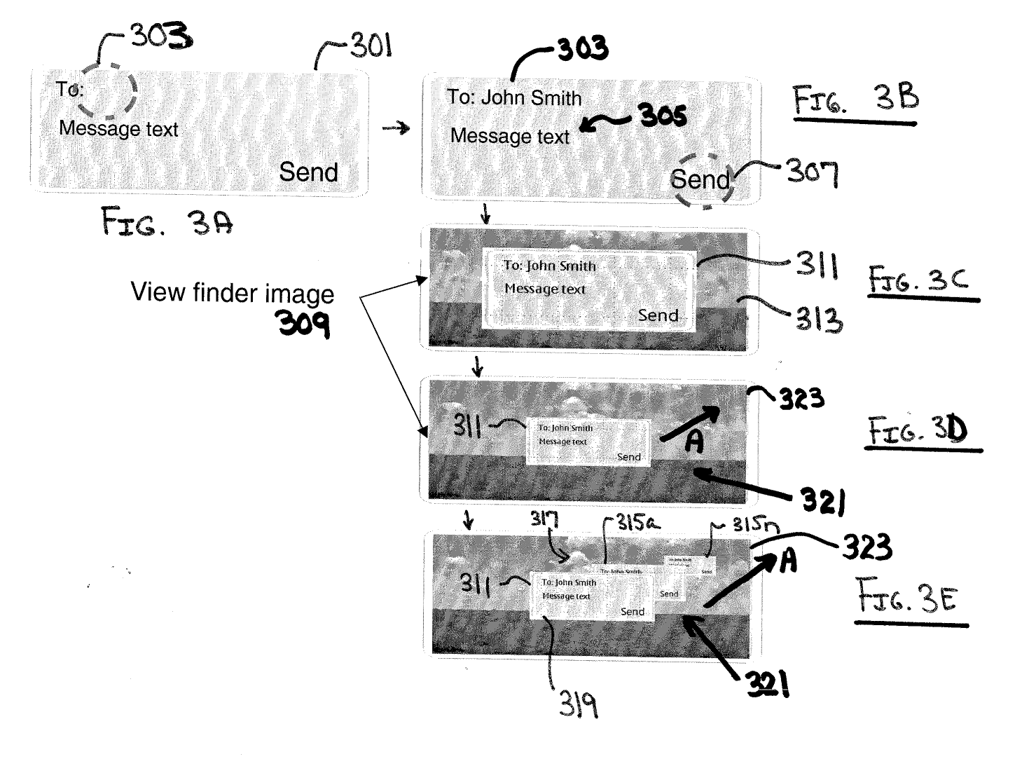

In one embodiment, referring to FIG. 2A, a message creation screen 201 for an exemplary messaging application is illustrated. The message creation screen 201 generally allows the sender 101, also referred to herein as the “user”, to designate or select one or more recipients 103 for a messaging communication. In a known fashion, one or more communication contact data can be associated with a recipient 103, and selected as such. For purposes of this example, communication contact data is selected using a drop down menu 203 and can include, but is not limited to, a phone number, social networking services contact data or an email address. In alternate embodiments, the recipient 103 can be designated in any known fashion, such as for example, by manually entering a destination address or number for the contact or importing the recipient contact data from an address book or other suitable application.

Although the examples herein are described with respect to one recipient, in alternate embodiments, more than one recipient can be designated for a communication, as is generally known. When a message is sent to more than one recipient, the directional information pertaining to the one or more recipients can be selectively viewed or viewed as a group. For example, the sender 101 will select a particular recipient in order to view the directional information pertaining to the selected recipient, as is described herein. Alternatively, the directional information related to each recipient party can be presented simultaneously. In one embodiment, the directional information pertaining to each recipient can be individually highlighted or otherwise designated.

In one embodiment, referring to FIG. 2B, a message type 205, also referred to as emotive message icon 205, can be selected. As shown in FIG. 2B, and otherwise described herein, any one of a number of message or communication types 205a-205d can be made available for selection. In this example, the possible emotive message icon 205, also referred to as a “feeling-icon” can include, but is not limited to, a “hug” 205a, a “kiss” 205b, a “wake up” 205c and a “smile” 205d. Each message type 205 will be associated with a corresponding icon as is shown in the exemplary message types 205a-205d. In this example, the smile message type 205d is selected. Although not shown in this example, in one embodiment, in addition to selecting a message type 205, the sender 101 can also create or insert a message to be sent in addition to the message type 205, or separately. The message can include for example, text and other suitable attachments, such as multimedia files, for example. In alternate embodiments, any suitable method of selecting or designating a message type can be used.

Once the message is ready to be sent, the user activates the Send or transmit function of the sending device 102. As is shown in FIG. 2C, for example, a Send button 207 is used to activate the Send function of the device or messaging application. In alternate embodiments, any suitable method can be used to initiate the transmit function of the sending device 102 and send the message, including for example, a voice activated send command or a delayed send command.

The aspects of the disclosed embodiments provide the user with the sense that the message is traveling or otherwise moving to the recipient. Once the message is sent, in this example, the message screen 201 is zoomed out, or otherwise made to appear smaller in comparison to an overall size of the display area 207. This provides the user with the feeling of movement of the message screen 201. In alternate embodiments, any suitable indicator or icon can be used to provide the user with the feeling of the movement of the message from the user to the recipient.

In one embodiment, as shown in FIG. 2D, the message screen 201 appears against a background 209. In one embodiment, the background 209 is a camera image or viewfinder mode. In the camera image or viewfinder mode, an actual image view from a camera of the device 120 is used as the background image 209. In one embodiment, the message 201 can be provided in an approximate middle of the display area 207 and the background 209 is the camera image. The message 201 is augmented on top of the camera image or view. In alternate embodiments, any suitable background image can be used. In this example, the background 209 has a geographic theme or nature. In another embodiment, the background 209 could include a map or routing plan.

As shown in FIG. 2E as the message screen 201 of FIG. 2D continues to zoom out, giving the appearance of continued movement of the message screen 201. In one embodiment, when the camera view mode is activated, the appearance of the message screen 201 changes to a message sent screen 211. The message sent screen 211 in this example includes the recipient name 213 and the selected emotive message icon 205, which in this example is the smile icon 205d. The message sent screen 211 continues to zoom out as is shown in FIG. 2F. In the example shown in FIG. 2F, the message type icon 205 appears somewhat enlarged relative to the message sent screen 211, so that the sent message appears on “top” of the viewfinder content or background 209. The message 211 then appears to move or “fly” in the direction of the recipient in this augmented reality view

As shown in FIG. 2G, the message screen 211 of FIG. 2F has zoomed out (i.e. been decreased in size) to a point where it is no longer visible in the display 207 area. Only the emotive message icon 205, which in this example is the smile icon 205d, is presented in the display area 207 against the background 209. Although only the emotive message icon 205 is shown in FIG. 2G, in one embodiment, the message can be presented instead. Generally, this state of the camera view mode indicates that the sent message has reached the recipient 103. In alternate embodiments, any suitable view or indication can be used to provide the user with feedback on the state of the sent message. Although a gradual progression of zooming out is shown from the message creation screen 201 in FIG. 2D to the screen shown in FIG. 2G, in one embodiment, the screen shown in FIG. 2G could appear as the first screen after a message sent.

In accordance with one aspect of the disclosed embodiments, as the message is sent or reaches the recipient, information relating to a location of the device 104 of the recipient is obtained. The location information related to the sender's device 102 will already be known or will also be obtained in a similar fashion. The location information can be determined or obtained using any suitable locating device or method, including for example, global positioning systems, compasses, mapping and direction services, traffic conditions, accelerometers or other services or devices that obtain location information and/or provide directional or routing measurements and data. In alternate embodiments, any suitable device or system can be used to determine and/or identify location information related to the recipient as well as the user (sender). In one embodiment, the location information is obtained by or delivered to the location module 136 of FIG. 1B and is used to determine directional information from at least an approximate location of the sender's device 102 to at least an approximate location of the recipient's device 104.

The aspects of the disclosed embodiments also provide directional information feedback related to a sent message or communication. In one embodiment, referring to FIG. 2H, once the recipient location information is determined, the directional animation module of FIG. 1B will create or provide an animation 217 that indicates a general direction from the sender's device 102 towards the recipient's device 104. The animation can be static or dynamic. In the static case, the animation simply points in the corresponding direction, similar to a compass. In one embodiment, where the animation is dynamic, the animation appears to move across the display area 207 in a direction corresponding to the location of the communication device 104 of the recipient 103, relative to a current location of the sender's communication device 102. As shown in FIG. 2H, in this example, the animation includes presenting message type icon 206 adjacent to the message type icon 205. In alternative embodiments, only the message type icon 205 is presented. In order to present an appearance of movement, the message type icon 206 is spaced apart from, and is slightly smaller in size, than icon 205. In one embodiment, a connection or connector 215 can also be presented between the two icons 205 and 206.

In one embodiment, in order to show further movement or animation, or enhance the directional indication in the case of a static animation, as shown in FIG. 2I, a plurality of message type icons 206b-206c are presented, where each subsequent icon, such as icon 206a, is smaller in size than a previous icon, such as icon 205. Although in this embodiment each subsequent icon 206a is described as being smaller in size than a previous icon 205, this corresponds to the situation where the communication is sent, and presents the appearance that the communication is moving away from the user (sender). In the embodiment where the animation relates to a communication received in a device, the plurality of icons 206b-206c can be presented in a sequence that runs small to large, where each subsequent icon 206a is larger than the previous icon 205, to present an impression that the communication is approaching the recipient. Although only a certain number of additional message icons or images are shown in the figures, the number of additional icons shown in the figures is for illustration purposes only. The scope of the disclosed embodiments is not limited by the number of icons or images used in an animation, and in alternate embodiments any suitable number can be used. The use of multiple icons 206b, 206c is merely illustrative of providing (on a static figure) the impression of movement on a display. In alternate embodiments, a single icon or other suitable image or imagery can be used to show movement on a display. Thus, the aspects of the disclosed embodiments are not intended to be limited by the use of a single, or multiple icons, to present an impression of movement on a display.

The animation 217 shown in FIG. 2I provides the sender 101 with a general indication of a direction to the location of the recipient 103 relative to the sender 101 (in terms of their respective communication devices 102, 104) The animation sequence 217 presented by the one or more icons 205d, and 206a-206n, on the display area 207 generally points or moves towards a direction that corresponds to the approximate location of the recipient 103, relative to the current location of the sender 101 as determined from the location information. Although the animation sequence 217 is generally described herein as a series of icons, in one embodiment, the animation sequence 217 can comprise a single icon or image. For example, an image of a cord or line, such as a phone line, extending from the sender 101 towards the recipient 103 can be presented. In alternate embodiments, any suitable icon, image or graphic can be used that provides a sense of direction or connection between or towards a sender and a recipient.

As shown in FIG. 2I, the animation sequence 217 appears substantially along a continuum 219, beginning at origin 221 and continuing to at least the last icon 206c along the continuum 219. In the embodiment where the background 209 comprises a map, the end point 229 of the animation sequence or continuum 217 can be a point on the map that corresponds to the location of the recipient. In addition to pointing to the location on the map, in one embodiment, geographical location information can also be displayed that corresponds to the end point 229.

In one embodiment, where the background 209 is a map, the animation 217 can be provided as routing on the map, either in a dynamic or static mode. For example, the location information is used to develop routing information from the sender 101 to the recipient(s) 103. The animation 217 is presented as the route on the map. Although the map in this example is indicated as being the background 209, in one embodiment, the animation 217 is provided directly on a map, with providing map information in the background 209. The animation 217, or communication, follows the map routing. This can allow the sender 101 to “follow” the communication to the recipient.

As another example, in the map view, the sender can “virtually” travel to the location of the recipient. The background 209 can be provide as an “earth” or satellite image, such as that as might be seen from a camera view in an aircraft, satellite or space travel vehicle. The communication icon 205d can be “followed” as it travels to the location of the recipient in this view. Thus, in addition to providing directional information pertaining to a communication, in one embodiment, the user can see where the communication goes or comes from. The user can move the device 120 and follow the communication, even if the communication 205d moves outside of the display area 207 of the device 120.

For example, a message is to be sent to from party A to party B. Party A creates or writes the message and sends the message. The augmented reality view of the disclosed embodiments is activated showing the message icon 205d in the middle of the display area 207, with the background 209 being the viewfinder view from the camera of the device 120. If Party B is to the right side of Party A, the message icon 205d moves outside the display area 207 towards the right. Party A can move the device 120 and point it more towards right in order to follow the message icon 205d “flying” to the right and finally reaching the location of Party B as presented on the background 209.

In one embodiment, the animation 217 provides the impression of the icon(s) moving on or “flying” across the display area 207, particularly when the animation 217 is a dynamic animation. It is noted that although the animation 217 is described in terms of “icons”, in alternate embodiments any suitable image(s) or graphic(s) can be used for the animation. The aspects of the disclosed embodiments are not intended to be limited by the type of particular imagery used for the animation. Also, the animation 217 can be provided in any suitable orientation that provides a user with general directional information as described herein. In one embodiment, the animation 217 can be refreshed as the sender 101 gets closer to the recipient 103 in order to provide more detailed or specific direction or location information.

Referring to FIG. 2I, in one embodiment, the user can shift or reposition the communication device to move the view finder view. In FIG. 2I, the origin 221 of the animation 217 is located in an approximate middle of the display area 207 and extends or moves from the origin towards the right side 207b of the display area 207. In one embodiment, movement of the communication device can cause a corresponding change in the location of the origin 221 in the view finder view presented in the display area 207. For example, by moving the communication device to the right, in one embodiment, referring to FIG. 2J, the origin 221 shifts towards the left side of the display area 207. This allows the animation 217 to also shift to the right, and as shown in FIG. 2J, the animation 217 expands, providing a more detailed view of the animation 217. Thus, while in FIG. 2I the animation 217 ends at the right edge 207 of the display area 207, in FIG. 2J, the origin 221 is shifted and the continuum ends at a point 229 within the display area 207. This can provide a more exact view of the location of the other party. In the embodiment where the background 209 is a map view, the animation 217 shifts on the map. Movement of the communication device in other directions causes similar viewing changes. For example, moving the communication device to the left in FIG. 2I will provide a view with a shorter animation sequence 217. When the user sends a message, the aspects of the disclosed embodiments will show the direction of the recipient(s) 103 of the message. An animation 217 is provided in an augmented reality view. In one embodiment, the camera view finder is shown as the background 209 and a message icon 205a is added as a layer on top of this real life view. The icon 205d is moved in the direction of the recipient's 103 location. If the recipient 103 is a direction that does not correspond to a current direction that the device 120 is pointing to, the sender 101 can move the device 120 left or right to see the direction in which the message icon 205d is moving and where it “lands” (i.e.) where the recipient 103 of the message is.)

Referring again to FIG. 2I, in one embodiment, it is also possible to provide additional directional and navigation information related to the location of the recipient 103. For example, in one embodiment, a distance indicator field or window 223 is provided that shows the approximate distance between the sender 101 and the recipient 103. In the embodiment shown in FIG. 2I, the distance indicator field 223 is presented in the display area 207, although in alternate embodiments, the distance indicator field 223 can be presented in any suitable location or format. For example, in one embodiment, the animation 217 can comprise the distance indicator field, where the distance indicator field 223 starts at the origin 221 and continues, or is animated, across the display area 207 in an indicated direction.

In another example, referring to FIG. 2J, an additional information field 227 is provided. In this embodiment, the additional information field 227 includes, for example, the name of the location of the recipient 103 as well as the distance between the sender 101 and the recipient 103. In alternate embodiments, any suitable information or data can be provided in the additional information field 227. For example, directional information could be displayed, such as North, South, East or West, or variations thereof, to indicate a relative directional orientation of one party to the other party. The aspects of the disclosed embodiments are not intended to be limited by the type of information or content provided in the additional information field 227. In one embodiment, the location services module 140 of FIG. 1 obtains and processes the additional information for presentation in the display area 207.

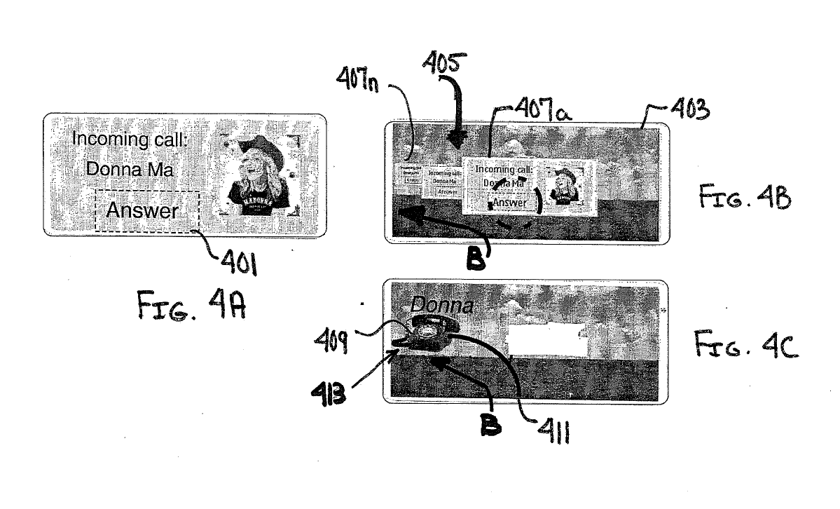

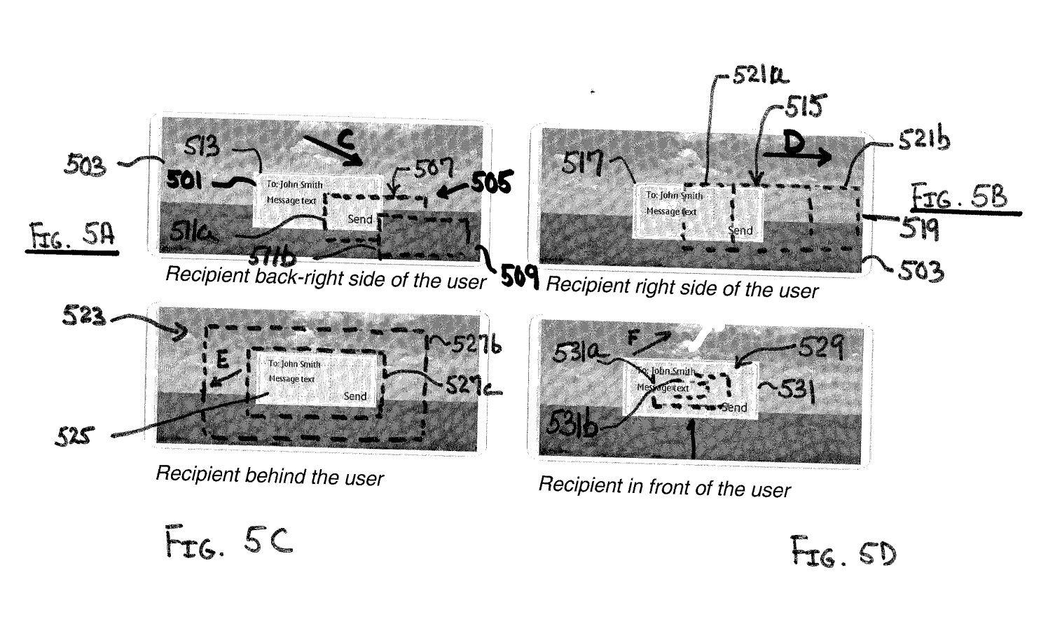

FIGS. 3A-3E illustrate one embodiment of the present application where a text message is sent. In this embodiment, a message recipient 303 is selected on a message creation screen 301. Message text 305 is added and the Send function 307 is activated. In this embodiment, once the message 305 is sent, the message screen 301 is zoomed out and the view finder mode is revealed as shown in FIG. 3C. In this example the view finder image state 309 includes a reduced size message screen 311 against a background 313 as shown in FIGS. 3C and 3D. In one embodiment, the background 313 is a “real environment” image, such as the camera view image. In alternate embodiments, the view finder mode 309 can include any suitable image or graphic against a background that provides the user with the impression that the message is being sent and/or delivered to the recipient and allows the user to “follow” the message to its destination.

In order to provide the animated directional information as described herein, as shown in FIGS. 3D and 3E, the reduced size message screen 311 can be animated in a direction of the recipient of the message, relative to a location of the sender. In FIG. 3D, animation 321 is provided in which the screen 311 is caused to appear to move in a direction A, which has been determined by the location module 136 and directional animation module 138 to be towards the relative location of the recipient. As shown in FIG. 3E, in this example, the animation 321 is further enhanced by the presentation of one or more subsequent message screens 315a-n in a sequence 317 where each subsequent screen, such as screen 315n, is smaller in size than the preceding screen 315a. Although in this example multiple screens are used to provide the directional animation 321, in an exemplary embodiment, the animation 321 is the image of only one screen moving against the background 313 towards the edge 323.

The aspects of the disclosed embodiments can also be applied to messages that were previously received or are stored in an inbox. For example, an incoming and outgoing messages are typically stored or saved in an “In-Box” or “Sent Items” folder, respectively, In one embodiment, when a message in either one of these folders is opened, a directional animation can be provided, as described herein, to illustrate where the message went to or came from, even though the message was previously sent or received. The animation 217 can be newly created, based on current or stored location data, or recreated from stored animation data. Where the animation is recreated from stored animation data, the animation 217 can provide directional information related to the communication, as of the time the communication was originally sent or received. In one embodiment, the animation 217, or another animation can be provided, that indicates a current or updated location(s) of the parties to the communication. For example, when a communication is originally sent, the parties to the communication will be at “original” locations. However, if the communication is not accessed in real time, but rather at a subsequent time, one or more of the parties may have changed their locations. The animation data can be updated to provide not only the “original” locations, but can also provide the “current” location data for the parties.

In one embodiment, the animations can also be configured to remain visible on the display for a certain period of time after the communication is detected. For example, after the visualization of the communication, as is described herein, the animation 217 can remain visible or active for a pre-determined time period. In one embodiment, the animation data can be stored and associated with the communication. This can provide a historical trace of the communication. Also, if the communication is stored and then later accessed, the saved animation data can be used to recreate the corresponding animation.

The aspects of the disclosed embodiments can also be applied to incoming communications, where an animation provides directional information related to an origin of the communication relative to the recipient. Referring to FIGS. 4A-4C, an incoming communication, such as call is detected, and a suitable incoming call screen 401 is presented on the display of the receiving communication device. When the call is answered, the incoming call screen 401 is zoomed out and the view finder mode 403 is revealed as shown in FIG. 4B. As shown in FIG. 4B, a series 405 of reduced size incoming call screens 407a-407n are presented, where each subsequent screen, such as screen 407b, is smaller in size than the preceding screen, such as screen 407a. In one embodiment, only a single screen 407a is used. The series of screens 407a to 407n provides a general directional indication B towards a location of the caller, relative to a location of the receiving communication device. In one embodiment, the series 405 of reduced size incoming call screens 407a-407n can be replaced with a suitable icon, such as the telephone icon 409. The telephone icon 409 is generally oriented on the view 403 in the general direction B, starting from the origin point 411 towards the location 413 of the icon 409. The icon 409 can be stationary, as shown in FIG. 4C, or can also be animated as otherwise described herein.

As noted herein, the directional information related to the location of the parties to a communication is animated. As is generally understood, animation is the rapid display of a sequence of one or more images, either two-dimensional or three-dimensional artwork or model positions, in order to create an impression or illusion of movement on the display. In the examples described previously, the animation originates at an origin point or other suitable location on the display and appears to move on the display in a direction that generally relates to the location of the other party based on the orientation and position of the displaying device. Referring to FIGS. 5A-5D, some general examples of the types of animation that can be used in conjunction with the disclosed embodiments are provided.

FIG. 5A illustrates the situation where the party, in this case the recipient 103, is located towards the back-right side of the user. It should be noted that although these examples are described in terms of viewing a directional animation on the sender's communication device 102, the aspects of the disclosed embodiments equally apply to viewing the directional animation described herein on the recipient's communication device 104, where the animation pertains to a direction towards the sender's communication device 102 from the recipient's communication device 104.

As shown in the example of FIG. 5A, the origin 501 is located in an approximate center of the display area 503. In alternate embodiments, the origin 503 can be any suitable location on the display area 501. As is shown in FIG. 5A, the directional animation 505 is in a direction C towards the right corner 509 of the display area 503. In this example, the animation 505 is shown as a series 509 of box outlines. In alternate embodiments, the communication icon is used and moved in a manner to provide the impression of movement toward the user (i.e. the message moving towards the device and through it). It will be understood that in alternate embodiments, any suitable image, icon or graphic can be used for purposes of the animation. For example, in one embodiment images of arrows or pointers could be used. For purposes of the animation 505, in one embodiment, each element 511a, 511b in the series 509 can be caused to cycle on and off in a sequential manner to provide the appearance of movement. After a predetermined time, the series 507 can be removed from the display area 503 or otherwise dimmed, and the animation 505 can again repeat itself. This causes the illusion of movement in the direction C. In one embodiment, the message screen 513 can be included in the animation and be caused to appear and re-appear as part of the animation 505. This animation 505 provides a general indication or feeling of movement of the message screen 513 towards the corner 509 of the display area 503.

FIG. 5B illustrates a situation where the recipient 103 is towards the right side of the sender 101. In this example, an animation 515 is provided that originates at or from the area of origin 517 and appears to move in a direction D towards the right side 519 of the display area 503. In this example, it is noted that a size of each image 521a, 521b is constant. In alternate embodiments, the size of each image 521a, 521b can be varied, such as shown in FIG. 5A.

FIG. 5C illustrates a situation where the other party is behind the user. In this example, the animation 523 appears to emanate from the origin 525 and move in a direction E, outwards, or towards the user. Each image 527a, 527b increases in size as the animation 523 progresses to give the impression that the animation is moving towards the user.

In the example illustrated in FIG. 5D, the other party is in the front of the user. The animation 529 emanates from the origin 531 and appears to move in a direction E, or away from the user into the display area 503. Each subsequent image 533a, 533b in this example is presented in a size that is smaller than the prior image, to provide the appearance of movement away from the user.

In the examples shown in FIGS. 5A-5D and with reference to the example shown in FIG. 2J, movement of the communication device can reposition the view finder image on the screen. For example, referring to FIG. 5A, moving the communication device to the right, can cause the origin 501 to shift to the left, within the limits of the display area 503. This movement can cause a corresponding expansion (or contraction) of the animation as described with reference to FIG. 2J.

In one embodiment, the animation can be adjusted or configured based on a proximity of the user to the recipient. In one embodiment, when the other party is relatively close to the user, an intensity of the animation, as measured in terms of frequency of repetition or contrast of the image(s), can be greater relative to a situation where the other party is farther away. For example, if a predetermined distance is 1 kilometer, and the distance between the parties is less than 1 kilometer, the animation can be presented with a high intensity and/or cycle at a higher frequency. In alternate embodiments, the animation or icon can be different for different distances and proximity. As the parties get closer together, relative to the pre-determined distance or other criteria, the intensity and frequency of the animation can continue to increase. However, if the distance between the parties is greater than the pre-determined distance, or the parties move, or are moving farther away from each other, the animation can be dimmed or cycle at a lower frequency, relative to the situation where the parties are within the pre-determined distance or moving closer together. In other embodiments, the animation might be combined with or include aural indicators. Although this example is defined in terms of distance, such as 1 kilometer, in alternate embodiments, any suitable unit of measure might be used.

By combining elements of surprise, augmented reality, location information, presence and services, the aspects of the disclosed embodiments allow for a standard or otherwise boring message to become informative and interesting. By being able to perceive the location of the other party, and/or other information related to the location, the user can enhance the communication experience. For example, the user sends a message to another party. When the message is sent, the directional animation described herein allows the user to see where the message is sent. The user can, among other things, determine a proximity to the other party and choose to call or meet with the other party.

In the embodiment where the user is provided with additional information related to the location of the other party, such as shops and restaurants, for example, the user can identify places or services of interest. For example, the user may know of or see a movie theater near the location of the other party. The aspects of the disclosed embodiments allow the user to readily recognize this information, based on the directional animation and/or additional information fields, and can ask the other party to obtain tickets.

The directional animation of the aspects of the disclosed embodiments can also allow the user to “follow” the communication or animation to the other party (where such a scenario is realistically possible). For example, where the parties are in relative proximity to each other, such as at a stadium, shopping mall or city center, the directional animation can be used as a navigation instrument to guide or direct the user towards the other party. The directional animation may also be useful in larger environments, such as the outdoors.

Although the aspects of the disclosed embodiments have been generally described with respect to an automatic determination of a location of the other party, in one embodiment, the other party can selectively enable whether location information will be determined. For example, if one party does not want their location information to be readily available to the other party, the delivery or obtaining of the location information can be selectively disabled or blocked. Alternatively, the communication delivered to the recipient may include a request to allow location information to be returned to the sender. In this case, the recipient may need to take some action, such as activating a key, to enable the location information of the recipient to be determined.

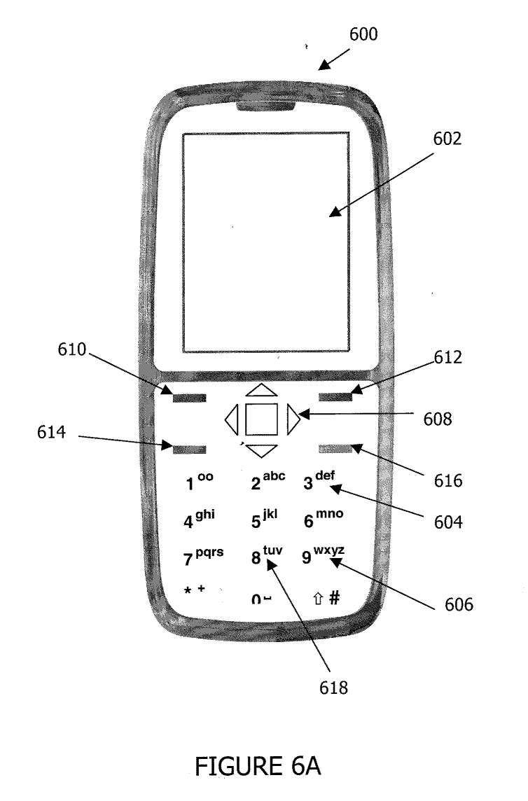

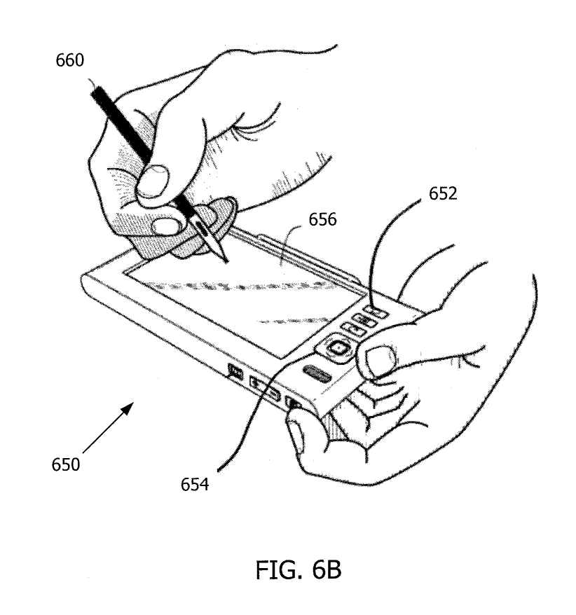

Some examples of devices on which aspects of the disclosed embodiments can be practiced are illustrated with respect to FIGS. 6A-6B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 6A illustrates one example of a device 600 that can be used to practice aspects of the disclosed embodiments. As shown in FIG. 6A, in one embodiment, the device 600 has a display area 602 and an input area 604. The input area 604 is generally in the form of a keypad. In one embodiment the input area 604 is touch sensitive. As noted herein, in one embodiment, the display area 602 can also have touch sensitive characteristics. Although the display 602 of FIG. 6A is shown being integral to the device 600, in alternate embodiments, the display 602 may be a peripheral display connected or coupled to the device 600.

In one embodiment, the keypad 606, in the form of soft keys, may include any suitable user input functions such as, for example, a multi-function/scroll key 608, soft keys 610, 612, call key 614, end key 616 and alphanumeric keys 618. In one embodiment, referring to FIG. 6B., the touch screen area 656 of device 650 can also present secondary functions, other than a keypad, using changing graphics.

As shown in FIG. 6B, in one embodiment, a pointing device, such as for example, a stylus 660, pen or simply the user's finger, may be used with the display 656. In alternate embodiments any suitable pointing device may be used. In other alternate embodiments, the display may be any suitable display, such as for example a flat display 656 that is typically made of a liquid crystal display (LCD) with optional back lighting, such as a thin film transistor (TFT) matrix capable of displaying color images. Aspects of the disclosed embodiments can also include head mounted displays, data glasses or other similar devices a user can wear to enter an augmented reality view.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, the device 600 can include an image capture device such as a camera 620 as a further input device. The device 600 may also include other suitable features such as, for example a loud speaker, tactile feedback devices or connectivity port. The mobile communications device may have a processor or other suitable computer program product connected or coupled to the display for processing user inputs and displaying information on the display 602 or touch sensitive area 656 of device 650. A computer readable storage device, such as a memory may be connected to the processor for storing any suitable information, data, settings and/or applications associated with each of the mobile communications devices 600 and 656.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the device 120 of FIG. 1B may be for example, a personal digital assistant (PDA) style device 650 illustrated in FIG. 6B. The personal digital assistant 650 may have a keypad 652, cursor control 654, a touch screen display 656, and a pointing device 660 for use on the touch screen display 456. In one embodiment, the touch screen display 656 can include the QWERTY keypad as discussed herein. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display and supported electronics such as a processor(s) and memory(s). In one embodiment, these devices will be Internet enabled and include Global Positioning System (“GPS”) and map capabilities and functions.

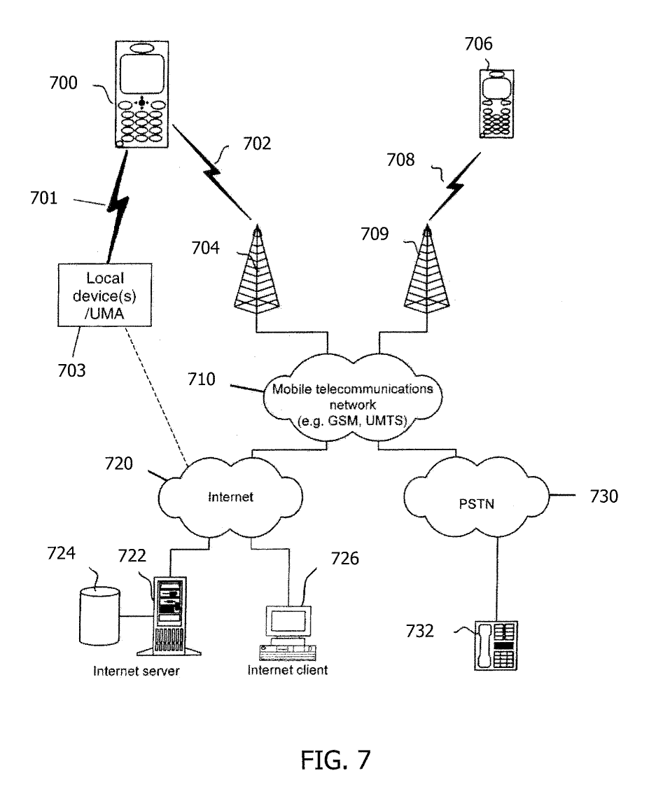

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 700 and other devices, such as another mobile terminal 706, a line telephone 732, a personal computer (Internet client) 726 and/or an internet server 722.

It is to be noted that for different embodiments of the mobile device or terminal 700, and in different situations, some of the telecommunications services indicated above may or may not be available. The aspects of the disclosed embodiments are not limited to any particular set of services or communication, protocol or language in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide-area network 720, which may be the Internet or a part thereof. An Internet server 722 has data storage 724 and is connected to the wide area network 720. The server 722 may host a worldwide web/wireless application protocol server capable of serving worldwide web/wireless application protocol content to the mobile terminal 700. The mobile terminal 700 can also be coupled to the Internet 720. In one embodiment, the mobile terminal 700 can be coupled to the Internet 720 via a wired or wireless link, such as a Universal Serial Bus (USB) or Bluetooth™ connection, for example.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting and any suitable type of link or short range communication protocol may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the communication module 134 of FIG. 1 is configured to interact with, and communicate with, the system described with respect to FIG. 7.

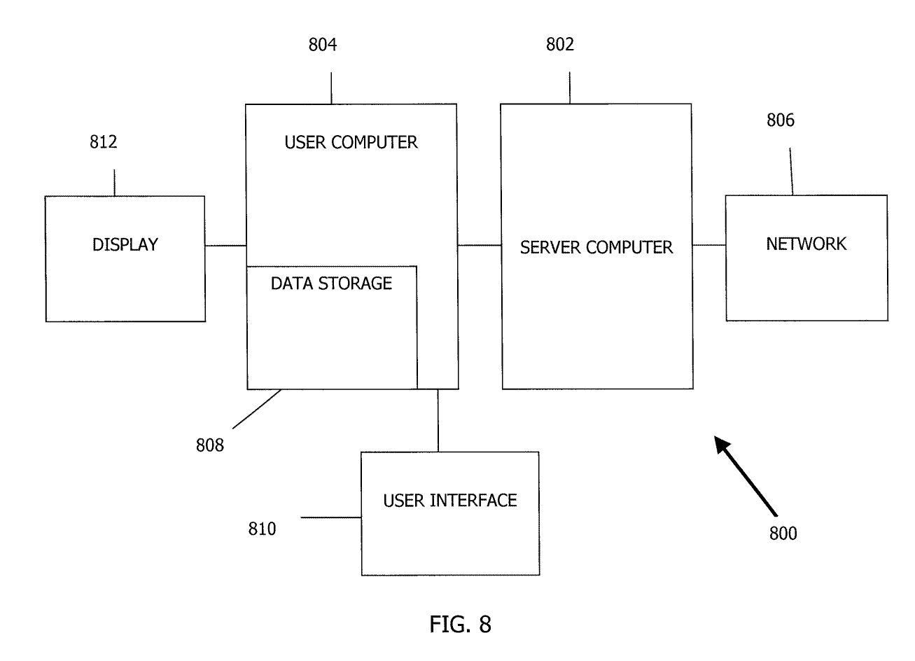

The disclosed embodiments may also include software and computer programs incorporating the process steps and instructions described above. In one embodiment, the programs incorporating the process steps described herein can be stored on or in a computer program product and executed in one or more computers. FIG. 8 is a block diagram of one embodiment of a typical apparatus 800 incorporating features that may be used to practice aspects of the invention. The apparatus 800 can include computer readable program code means embodied or stored on a computer readable storage medium for carrying out and executing the process steps described herein. In one embodiment the computer readable program code is stored in a memory(s) of the device. In alternate embodiments the computer readable program code can be stored in memory or other storage medium that is external to, or remote from, the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or other suitable connection or line, communication channel or link. In one embodiment, the communication channel comprises a suitable broad-band communication channel. Computers 802 and 804 are generally adapted to utilize program storage devices embodying machine-readable program source code, which is configured to cause the computers 802 and 804 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor(s) for executing stored programs. Computer 802 may include a data storage device 808 on its program storage device for the storage of information and data. The computer program or software incorporating the processes and method steps incorporating aspects of the disclosed embodiments may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries, as described with reference to FIG. 1B, for example.

The aspects of the disclosed embodiments provide for using augmented reality in mobile communication devices while sending and receiving communications, such as messages and calls. Location data pertaining to the sender and recipient is obtained and is used to provide a directional indicator and/or animation during the communication. The directional animation will provide a general directional indication towards the other party and can also enable the ability to “follow” the animation towards the other party. The directional animation can also include other information, such as a distance between the parties, a location name or a description of services and facilities near the location of the other party.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. A method comprising:
detecting in a communication device a communication between a sender and a recipient;
determining a location of the sender;
deterring a location of the recipient;
determining a direction between the location of the recipient relative to the location of the sender; and
providing a directional animation on a display of the communication device, wherein the directional animation is generally in a direction from the location of the sender towards the location of the recipient.

2. The method of claim 1 wherein the directional animation is a directional indicator on the display.

3. The method of claim 1 wherein the direction animation is presented together with a real life image on the display.

4. The method of claim 1 wherein the direction animation comprises a directional three-dimensional sound.

5. The method of claim 1 further comprising changing a position of the communication device to relocate an origin point of the animation on the display.

6. The method of claim 1 further comprising presenting the directional animation as a route on a map.

7. The method of claim 1 further comprising, when the communication is sent from the communication device, providing information on the display pertaining to the location of the recipient of the communication, wherein the information further includes a list of services near the location of the recipient.

8. The method of claim 1 further comprising, when the communication is sent from the communication device;
providing a sent communication indicator on the display and moving the sent communication indicator on the display in the direction towards the location of the recipient relative to the location of the sender.

9. The method of claim 8 further comprising moving the sent communication indicator on the display in a manner that causes the sent communication indicator to appear more distant to the sender.

10. The method of claim 1, further comprising, when the communication is sent from the communication device, providing on the display a first indicator representing the location of the sender and a second indicator representing the communication being sent, the second indicator being positioned on the display relative to the first indicator to provide a indication of the direction to the recipient relative to the location of the sender.

11. The method of claim 10 wherein the second indicator is caused to move on the display towards a position on the display that corresponds to the direction towards the location of the recipient.

12. The method of claim 11 wherein the second indicator comprises a series of indicators appearing on a continuum.

13. The method of claim 1 wherein the directional animation further comprises one or more directional indicators animated against a background image on the display.

14. An apparatus comprising:
a location module processor configured to determine location data corresponding to a geographical location of a sender and a recipient to a communication;
a directional animation module processor configured to receive the location data and provide a directional animation on a display of a communication device, the directional animation configured to indicate a relative direction from a location of the sender of the communication to a location of the recipient of the communication.

15. The apparatus of claim 14 further comprising a location services module processor configured to determine at least one service corresponding to the location of the recipient, when the communication is sent from the communication device and provide an information window on the display identifying the at least one service.

16. The apparatus of claim 14 wherein the apparatus comprises a mobile communication device.

17. The apparatus of claim 14 wherein the directional animation module processor is further configured to provide, when the communication is sent from the communication device, a sent communication indicator on the display of the communication device after the communication is sent and move the sent communication indicator on the display in a direction that corresponds to the relative direction towards the location of the recipients.

18. The apparatus of claim 14 wherein the directional animation module processor is further configured to provide a first indicator on the display representing the location of the sender and a second indicator representing the communication being sent, the second indicator being positioned on the display relative to the first indicator to provide a indication of the direction to the recipient relative to the location of the sender.

19. The apparatus of claim 18 wherein the directional animation module processor is further configured to cause the second indicator to move towards a position on the display that corresponds to the direction towards the location of the recipient.

20. A computer program product comprising a computer-readable medium bearing computer code embodied therein for use with a computer, the computer program code comprising:
code for detecting in a communication device a communication between a sender and a recipient;
determining a location of the sender;
deterring a location of the recipient;
determining a direction between the location of the recipient relative to the location of the sender; and
providing a directional animation on a display of the communication device, wherein the directional animation is generally in a direction from the location of the sender towards the location of the recipient.

21. The computer program product of claim 20 further comprising code for providing a sent communication indicator on the display and moving the sent communication indicator on the display in the direction towards the location of the recipient relative to the location of the sender.
